(19) United States
(12) Patent Application Publication
(10) Pub. No.: US 2003/0222970 A1
(43) Pub. Date: Dec. 4, 2003

(54) Device for producing a printing form

(76) Inventors: Andreas Detmers, Heddesheim (DE); Claus Harbach, Borgdorf (DE); Bernd Lassen, Monkeberg (DE); Sven Mader, Dielheim (DE); Christian Meier, Schriesheim (DE); Burkhard Paasch, Wahlstorf (DE); Lars Paulsen, Hollingstedt (DE); Markus Uihlein, Heidelberg (DE); Bernhard Zintzen, Heidelberg (DE)

Correspondence Address: LERNER AND GREENBERG, P.A., POST OFFICE BOX 2480, HOLLYWOOD, FL, 33022-2480, US

(21) Appl. No.: 10/446,391

(22) Filed: May 28, 2003

(30) Foreign Application Priority Data
May 28, 2002 (DE) 102 23 645.3

(51) Int. Cl. B41J 27/00

(52) U.S. Cl. 347/256

(57) ABSTRACT

A device for producing a printing form includes a radiation source for emitting at least one imaging beam directed to a material whereon an image is to be set. A device is provided for positioning the radiation source relative to and parallel to a surface of the material. A shutter is to be positioned for shielding between the radiation source and the material when an image is not being set on the material. An element is actionable for positioning the shutter while an image is being set on the material.

### BACKGROUND OF THE INVENTION

1. Field of the Invention

The invention relates to a device for producing a printing form, including a radiation source for emitting at least one imaging beam directed to a material whereon an image is to be set. A device is provided for positioning the radiation source relative to and parallel to the surface of the material. A shutter is to be positioned for shielding between the radiation source and the material when an image is not being set on the material.

In order to protect imaging optics against contamination, in particular in material-removing imaging methods, German Published, Non-prosecuted Patent Application DE 100 13 454 A1, corresponding to U.S. Pat. No. 6,346,961, describes a device for producing a printing form, which includes a slide that is positionable parallel to the surface of a printing form blank. The slide is shieldingly movable in front of a radiation source, when imaging is not being performed. The slide, which is provided with light pass-through openings, is positioned by a cam engaging with a driver or entrainer element.

A flat shutter is employed in a device according to U.S. Pat. No. 5,936,652, for the purpose of protecting an array of lenses. The flat shutter is positionable by a separate actuator transversely to light sources which are disposed in a longitudinal direction.

In an imaging device disclosed in Japanese Patent Application JP 60-44194 A, individual flat aperture elements are assigned to a row of light pass-through openings, each of which are coupled with a respective horizontally acting actuator. The actuators are operable independently of one another, so that individual light pass-through openings can be shuttered or closed selectively.

Heretofore known devices have shutter or closure elements which have been provided at a relatively high outlay with respect to layout and construction, and are expensive with respect to material and other costs.

Also known heretofore are imaging devices wherein gas flows serve for protecting optical elements.

German Utility Model DE 298 16 107 U1 shows an alternative embodiment or variant wherein a small quantity of protective gas flows continuously through a housing and escapes from openings formed in the housing. A gas flow is produced which prevents an objective lens from being contaminated by dirt particles released during a machining operation with a laser radiation source.

In a laser imaging system according to Japanese Patent Application JP 2001056569, a shield matched to the beam path serves for protecting a condenser lens against removed particles. In that regard, the interior of the shield can be placed under pressure, so that the particles do not reach the surface of the condenser lens.

### SUMMARY OF THE INVENTION

It is accordingly an object of the invention to provide a device for producing a printing form, which overcomes the hereinafore-mentioned disadvantages of the heretofore-known devices of this general type, which has minimal expenditure and which permits reliable protection of optical imaging elements.

With the foregoing and other objects in view, there is provided, in accordance with the invention, a device for producing a printing form, comprising a radiation source for emitting at least one imaging beam directed to a material whereon an image is to be set. A device is provided for positioning the radiation source relative to and parallel to the surface of the material. A shutter is to be shieldingly positioned between the radiation source and the material when an image is not being set on the material. An element is actionable for positioning the shutter while an image is being set on the material.

In accordance with another feature of the invention, the device for producing a printing form further includes a device for producing a shielding gas flow between the radiation source and the material. The shutter is positionable by action of a compressed gas source for producing the gas flow.

In accordance with a further feature of the invention, the shutter is constructed as a strip-shaped slide.

In accordance with an added feature of the invention, the device for producing a printing form further includes at least one pneumatic operating cylinder with which the shutter is coupled.

In accordance with an additional feature of the invention, when the material is disposed on the surface of a rotating cylinder, the shutter is positionable perpendicularly to the axis of rotation of the cylinder.

In accordance with yet another feature of the invention, the shutter is vertically positionable, when the axis of rotation of the cylinder is aligned horizontally.

In accordance with yet a further feature of the invention, the device for producing a printing form further includes a device for producing a shielding gas flow between the radiation source and the material. The device for producing the gas flow includes at least one mechanical element constructed as a shutter. The mechanical element, when an image is not being set on the material, is shieldingly positionable between the radiation source and the material.

In accordance with yet an added feature of the invention, when the material is disposed on the surface of a rotating cylinder, the mechanical element is positionable perpendicularly to the axis of rotation of the cylinder.

In accordance with yet an additional feature of the invention, the mechanical element is vertically positionable, when the axis of rotation of the cylinder is aligned horizontally.

In accordance with a concomitant feature of the invention, the shutter is formed with at least one beam pass-through opening. When an image is not being set on the material, the shutter is positionable shieldingly between the radiation source and the material by action of the positioning device, and is guidable parallel to a positioning direction of the positioning device. The shutter, in a stop position of the radiation source, rests against a stop fixed to a frame of the printing-form producing device, counter to action of a spring, for preventing passage of beams onto the material and, in an operating position of the radiation source, rests against a stop formed on the radiation source, due to the force of the spring, for permitting passage of beams onto the material.

The core of the invention is that the positioning of one or more shutters is performed by using drive energy originating from elements which are already supplied with energy in order to perform the image-setting or imaging process. Thus, no additional energy has to be provided for positioning a shutter.

In an advantageous further embodiment or variant of the invention, in order to position a shutter, use is made of the same compressed air that is also used for blowing on or blasting the surface of a material upon which an image is to be set, in order to keep an imaging area free of contamination. A pneumatic cylinder that is coupled with the shutter can also be actuated for this purpose. The shutter exposes the imaging beam path whenever the compressed air is provided. At all other times, the imaging beam path remains closed, so that the imaging beams cannot emerge freely.

In a further embodiment or variant, a housing for guiding a protective gas flow is provided simultaneously as a shutter. For this purpose, the housing or mechanical elements connected to the housing are accommodated in guides so that they are displaceable or pivotable. When the protective gas flow is switched on during imaging, the housing or the aforementioned elements are then brought into a position permitting free passage of imaging beams. As in the case of the first-mentioned variant, the drive of the housing can be carried out pneumatically with the protective gas under pressure. However, it is also possible to position the housing in an imaging position and in a rest position with a separate actuator, such as a pneumatic operating cylinder or an electromagnetic actuator.

In a further embodiment or variant, the force of a spring and an actuator for positioning a radiation source serve for positioning a shutter.

Other features which are considered as characteristic for the invention are set forth in the appended claims.

Although the invention is illustrated and described herein as embodied in a device for producing a printing form, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1 and 2 are diagrammatic, side-elevational, partly sectional views of an imaging device with a pneumatically positionable shutter in respective phases wherein imaging is not being performed and wherein imaging is being performed;

FIGS. 3 and 4 are views similar to FIGS. 1 and 2 of an imaging device with a positionable extractor or exhauster housing serving as the shutter;

FIG. 5.1 is a longitudinal-sectional view of an imaging device with a shutter acting counter to a spring; and

FIGS. 5.2 to 5.4 are fragmentary, sectional views of FIG. 5.1 showing the shutter in different operating phases thereof.

### DESCRIPTION OF THE PREFERRED EMBODIMENTS

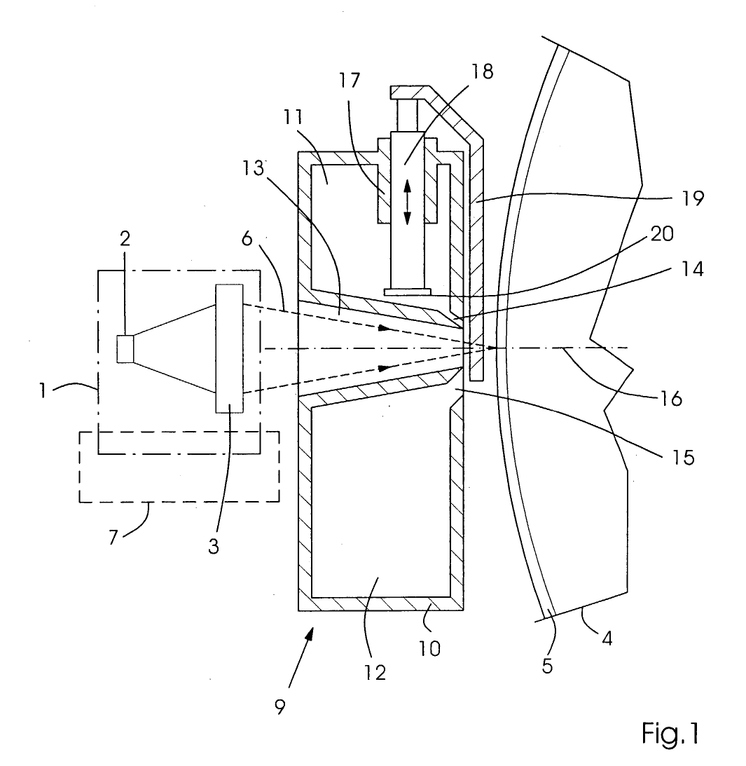

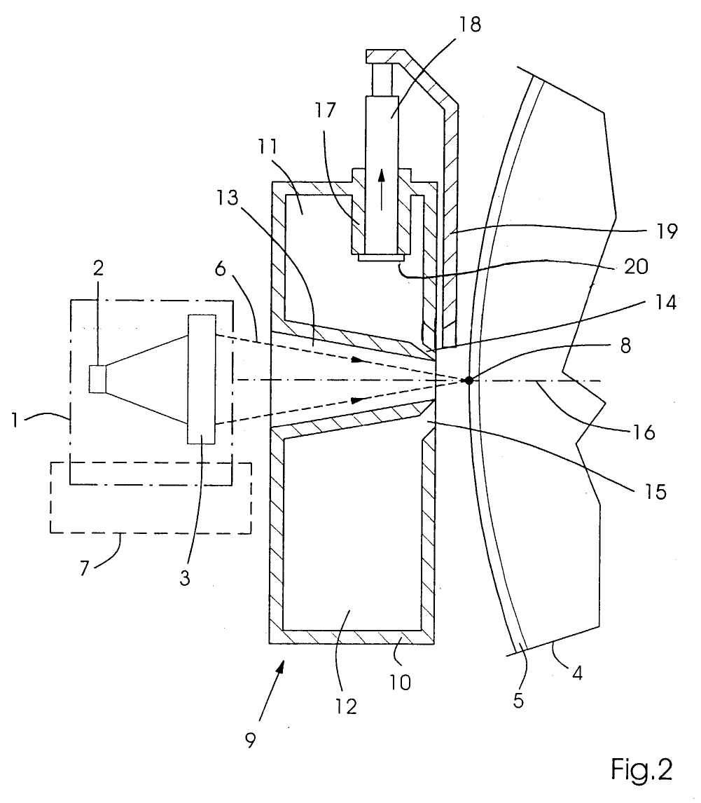

Referring now to the figures of the drawings in detail and first, particularly, to FIGS. 1 and 2 thereof, there is seen an imaging device having an imaging head 1 provided with a plurality of laser diode arrays 2 having optical projecting elements 3. The laser diode arrays 2 are built up row-wise and aligned along a line extending parallel to the axis of rotation of a printing-form cylinder 4, whereon a printing-form blank 5 is mounted. The laser diode arrays 2 radiate in the direction of the axis of rotation of the printing-form cylinder 4. Beams 6 from a laser diode are focused by a respective optical imaging element 3 onto the surface of the printing-form blank 5, in order to produce an image point or dot thereat which accepts printing ink. In order to be able to cover the entire surface of the printing-form blank 5, the imaging head 1 is positionable in the direction of the axis of rotation on a slide 7, while the printing-form cylinder 4 rotates. The slide 7 is held in a linear guide and coupled with a stepping motor drive. The printing-form cylinder 4 is coupled with an individual drive, and the rotational position of the cylinder 4 is registered by a rotary encoder.

As shown in FIG. 2, when a beam 6 strikes the printing-form blank 5, the uppermost layer of the printing-form blank 5 is removed in accordance with an image. In order to prevent removed particles from depositing on the optical elements 3, a blasting and suction device 9 is provided opposite a line with the focal points 8 on the printing-form blank 5. The blasting and suction device 9 includes a housing 10 having a blast air chamber 11, a suction air chamber 12 and light pass-through slots 13 located therebetween and extending over the entire width of the printing-form cylinder 4. Close to the light pass-through slots 13 are an air outlet slot 14 and an air inlet slot 15 respectively formed in the blast air chamber 11 and the suction air chamber 12. A plurality of operating cylinders 17 are disposed in the blast air chamber 11 in a direction perpendicular to an optical axis 16. The operating cylinders 17 project into the blast air chamber 11 and form a vertical longitudinal guide for operating pistons 18. A strip-shaped slide or shutter 19 is coupled with the operating pistons 18.

In FIG. 1, the position of the shutter or slide 19 is shown in a lower position thereof. The blast air chamber 11 is not under pressure, so that the operating piston 18 with the slide 19 is moved downwardly due to the action of the force of gravity or the action of a spring, so that the light pass-through slot 13 is covered by the slide 19 and no laser beams 6 can reach the surface of the printing-form blank 5. Since no imaging takes place in this position of the slide 19, no protective air curtain is required between the air outlet slot 14 and the air inlet slot 15 in front of the light pass-through slot 13.

FIG. 2 illustrates the position of the slide 19 during the imaging operation. The blast air chamber 11 is placed under pressure, so that the operating pistons 18 are forced upwardly, until they rest with stops 20 on a lower collar of the operating cylinders 17. The blast air chamber 11 is therefore an element that comes into action during imaging. The slide 19 is then in the upper position thereof and opens the passage for the beams 6 through the light pass-through slots 13 onto the surface of the printing-form blank 5. When a laser diode belonging to the laser diode array 2 is activated, material is removed from the surface of the printing-form blank 5, so that an image point or dot is produced at the focal point 8. Air emerges through the air outlet slot 14 from the blast air chamber 11 which is placed under pressure, and air is simultaneously sucked out of the suction air chamber 12. The air flow between the air outlet slot 14 and the air inlet slot 15 prevents removed particles from reaching the optical element 3.

The system including the housing 10 and the slide 19 can be provided repeatedly over the width of the printing-form cylinder 4. The slides 19 can additionally be seated in lateral guides.

Elements with the equivalent function described hereinbefore with respect to FIGS. 1 and 2 are identified hereinafter by the same reference numerals, with regard to the remaining figures of the drawings.

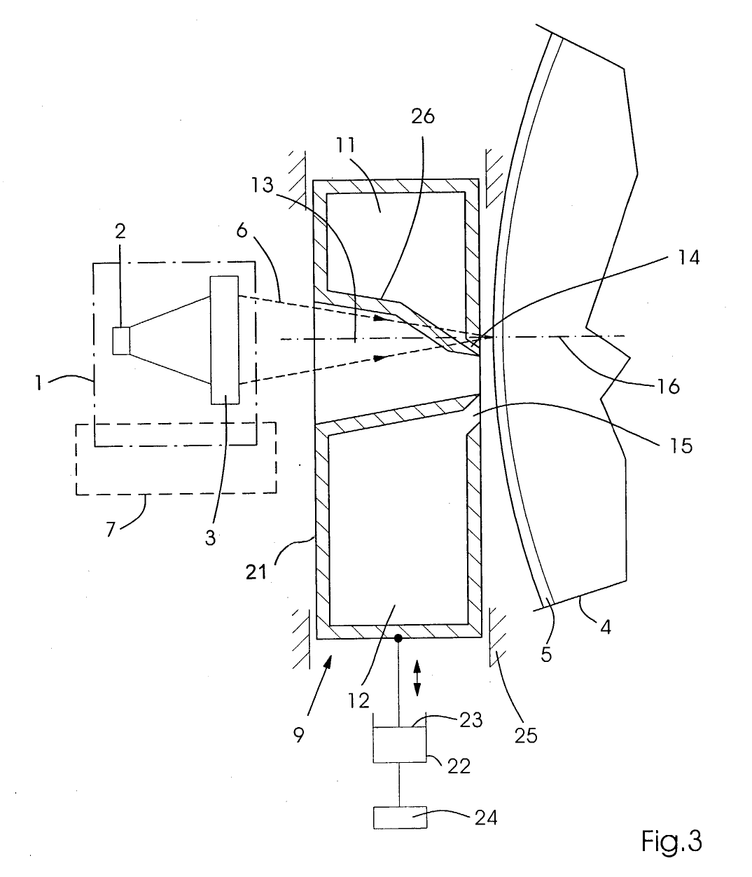

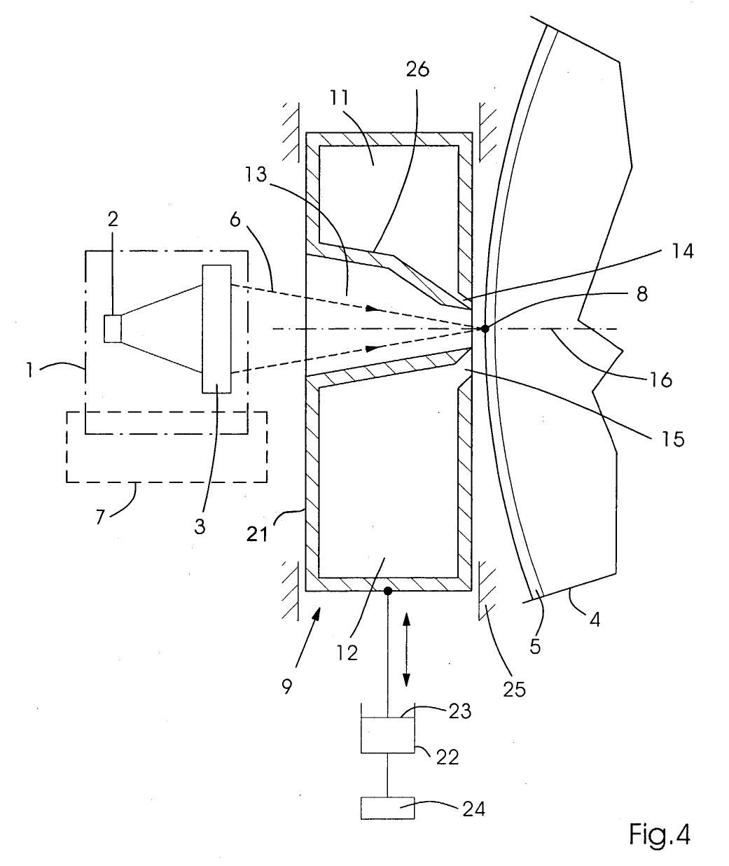

Another embodiment of the invention or a variant having a displaceable housing 21 for forming an air curtain for protecting the optical components 3 is shown in FIGS. 3 and 4. In contrast with the embodiment of FIGS. 1 and 2, the housing 21 of FIGS. 3 and 4 fulfills a dual function.

As FIG. 3 illustrates, the housing 21 acts as a shutter for the laser beams 6. The housing 21 is connected to an adjusting device, which includes an operating cylinder 22, operating pistons 23 and a compressed air source 24. The housing 21 is mounted in vertical longitudinal guides 25. The housing 21 is formed with a light pass-through slot 13 which is asymmetric with respect to the optical axis 16. The blast air chamber 11 is formed with a wall 26, which faces the light pass-through slot 13 and has an angular nick formed therein. FIGS. 3 illustrates the lower position of the housing 21, which is achieved by positioning the operating piston 23 in the operating cylinder 22 by the compressed air source 24. In this position of the housing 21, the beams 6 strike the angularly nicked part of the wall 26. The angularly nicked part of the wall 26 is inclined with respect to the optical axis 16 so that no direct or reflected beams 6 pass through the light pass-through slot 13 onto the surface of the printing-form blank 5. In order to suppress the reflections, the parts of the housing 21 facing towards the optical axis 16 are formed so as to be poorly reflective.

FIG. 4 shows the housing 21 in the imaging position. By using the operating cylinder 22 and the operating piston 23, the housing 21 has been moved upwardly in the longitudinal guides 25, so that the beams 6 can pass unimpededly through the light pass-through slot 13 and strike the surface of the Printing-form blank 5. The blast air chamber 11 is subjected to compressed air, while vacuum is produced in the suction air chamber 12. As a result, an air curtain is formed in front of the light pass-through slot 13, and prevents removed particles from being deposited on the optical elements 3.

According to FIGS. 3 and 4, the housing 21 is displaced in vertical direction in the longitudinal guide 25. Of course, displacements and rotations in other directions and about different axes are also possible, as long as the housing 21 exposes the beam path when it reaches the imaging position and blocks the beams 6 when it reaches the shuttered or closing position.

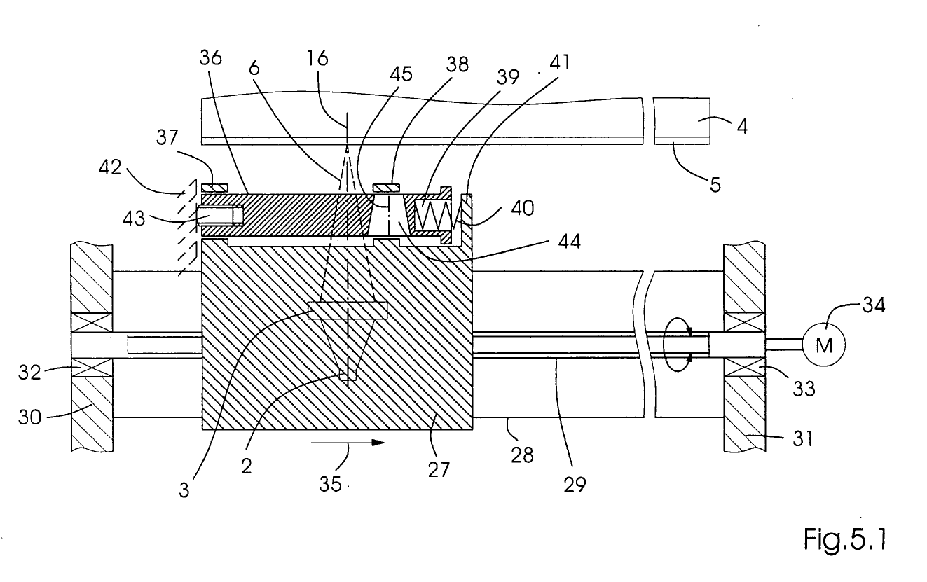

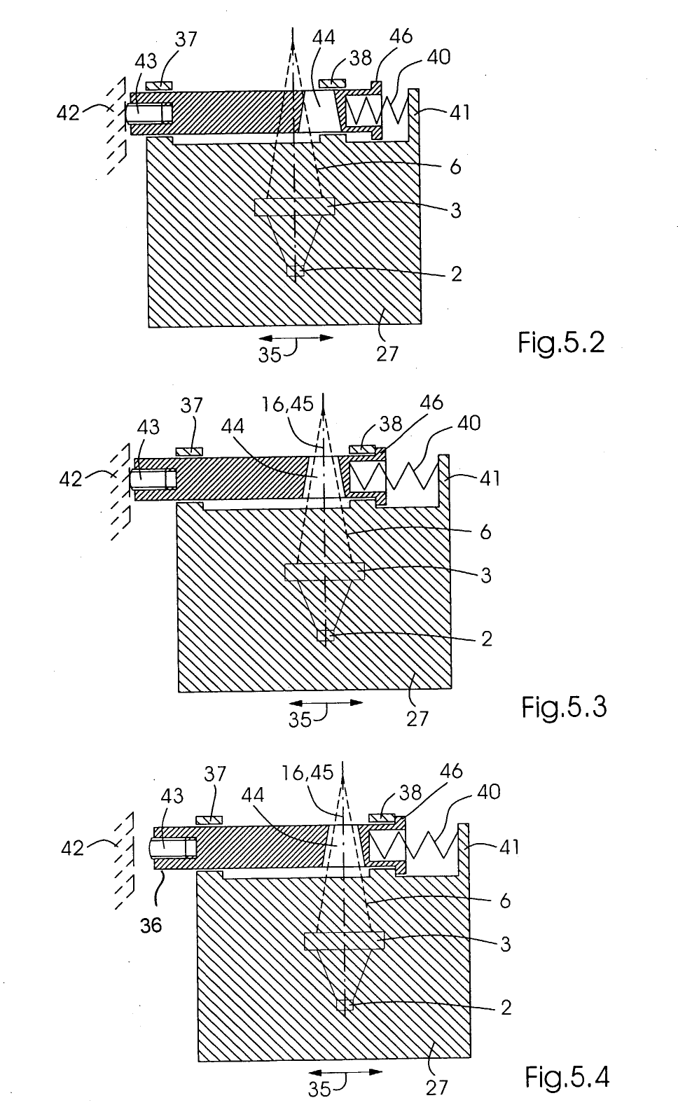

FIGS. 5.1 to 5.4 show a device for producing a printing form, wherein an imaging head 27 is positionable in a linear guide 28 by a worm or screw drive 29 between two side walls 30 and 31. The worm drive 29 is accommodated in bearings 32 and 33 provided in the side walls 30 and 31, respectively, and coupled with a stepping motor 34. The worm drive 29 has a non-illustrated nut, which is firmly coupled with the imaging head 27, i.e., when the screw drive 29 is rotated by the motor 34, the imaging head 27 is moved in lateral direction as represented by the arrow 35. The imaging head 27 contains a laser diode array 2 and an optical imaging element 3 for focusing the beams 6 from a laser diode onto the surface of a printing-form blank 5, which is clamped on a printing-form cylinder 4. The special feature of this embodiment or variant of the invention is that a shutter part 36 is disposed so as to be displaceable on the imaging head 27. In order to guide the shutter part 36 on the imaging head 27 in the direction of the arrow 35, guide elements 37 and 38 are provided on the imaging head 27. The shutter part 36 is formed with a recess 39, wherein a spring 40 is seated. The spring 40 is braced against a holder 41 of the imaging head 27 and exerts a force in the direction of the arrow 35 on the shutter part 36. In the vicinity of the side wall 30, there is provided a fixed stop 42 for a stop screw 43, which is adjustably seated on the shutter part 36. The shutter part 36 is formed with a beam pass-through opening 44 having an axis of symmetry 45 extending parallel to the optical axis 16 of the beams 6 originating from the laser diode array 2.

In FIG. 5.1, the imaging head 27 has been moved by the stepping motor 34 into a stop position. In this position, the stop screw 43 has run against or onto the stop 42. The shutter part 36 is forced in a direction towards the holder 41 counter to the force of the spring 40. The axis of symmetry 45 and the optical axis 16 are spaced from one another a distance which is greater than the flare or opening width of the beam pass-through opening 44, so that the beams 6 are prevented from striking the surface of the printing-form blank 5.

As FIG. 5.2 illustrates, the stop screw 43 remains disposed against or on the stop 42, due to the action of the spring 40, after the imaging head 27 is moved out of the stop position.

As FIG. 5.3 illustrates, the imaging head 27 has been moved in the direction 35 from the stop position to such an extent that the stop screw 43 remains just resting against or on the stop 42 due to the action of the spring 40, and the axis of symmetry 45 of the beam pass-through opening 44 is aligned with the optical axis 16.

As illustrated in FIG. 5.4, the shutter part 36 remains in position relative to the imaging head 27 when the imaging head 27 is moved even farther away from the stop 42, and the stop screw 43, accordingly, lifts off or away from the stop 42. The spring 40 presses the shutter part 36 by an extension 46 thereof against the guide element 38, which acts in the directions of the double-headed arrow 35 as a stop and as a driver or retainer, respectively.

A shutter configuration of the type shown in FIGS. 5.1 to 5.4 can be provided two or more times over the width of a printing-form cylinder 4, as required. In any case, the beam paths from the laser diode arrays 2 are exposed only when the imaging head or heads are moved out of the protective stop position.

We claim:

1. A device for producing a printing form, comprising:
a radiation source for emitting at least one imaging beam directed to a material whereon an image is to be set;
a device for positioning said radiation source relative to and parallel to a surface of the material;
a shutter to be positioned for shielding between said radiation source and the material when not setting an image on the material; and
an element actionable for positioning said shutter when setting an image on the material.

2. The device for producing a printing form according to claim 1, further comprising a device for producing a shielding gas flow between said radiation source and the material, said shutter to be positioned by action of a compressed gas source for producing said gas flow.

3. The device for producing a printing form according to claim 2, wherein said shutter is a strip-shaped slide.

4. The device for producing a printing form according to claim 2, further comprising at least one pneumatic operating cylinder coupled with said shutter.

5. The device for producing a printing form according to claim 2, wherein the material is disposed on a surface of a rotating cylinder, and said shutter is to be positioned perpendicularly to an axis of rotation of the cylinder.

6. The device for producing a printing form according to claim 5, wherein said shutter is to be vertically positioned when the axis of rotation of the cylinder is aligned horizontally.

7. The device for producing a printing form according to claim 1, further comprising a device for producing a shielding gas flow between said radiation source and the material, said device for producing the gas flow including at least one mechanical element constructed as a shutter, said mechanical element being positioned for shielding between said radiation source and the material when an image is not being set on the material.

8. The device for producing a printing form according to claim 7, wherein the material is disposed on a surface of a rotating cylinder, and said mechanical element is to be positioned perpendicularly to an axis of rotation of the cylinder.

9. The device for producing a printing form according to claim 8, wherein said mechanical element is to be vertically positioned when the axis of rotation of the cylinder is aligned horizontally.

10. The device for producing a printing form according to claim 1, further comprising a frame stop, a stop on said radiation source, and a spring associated with said shutter, said shutter having at least one beam pass-through opening formed therein, said shutter to be positioned for shielding between said radiation source and the material by action of said positioning device when not setting an image on the material and to be guided parallel to a positioning direction of said positioning device, said shutter, in a stop position of said radiation source, resting against said frame stop counter to action of said spring, for preventing passage of beams onto the material and, in an operating position of said radiation source, resting against said stop on said radiation source, due to the force of said spring, for permitting passage of beams onto the material.
